(19) United States
(12) Patent Application Publication
(10) Pub. No.: US 2018/0369072 A1
(43) Pub. Date: Dec. 27, 2018

(54) Film Dispensing Device For Delivery Of An Active Ingredient

(71) Applicant: Resolve Digital Health Inc., Toronto (CA)

(72) Inventor: Robert ADELSON, Vaughn (CA)

(73) Assignee: Resolve Digital Health Inc., Toronto (CA)

(21) Appl. No.: 16/018,985

(22) Filed: Jun. 26, 2018

Related U.S. Application Data
(60) Provisional application No. 62/525,565, filed on Jun. 27, 2017.

(51) Int. Cl. A61J 7/00; B65D 83/08

(52) U.S. Cl. CPC A61J 7/0076; B65D 83/0817; B65D 83/0841

(57) ABSTRACT

The present disclosure relates to a film dispensing device, said device including: a housing defining a dispensing orifice; a cartridge storing a film rolled around a bobbin, said cartridge including: a chamber holding said rolled film therewithin, said chamber defined by base, front wall, rear wall and a plurality of side walls of said cartridge, wherein said front wall defines an opening to allow ejection of said film; at least one driving roller to drive said film; a roller biasing element, said roller biasing element configured to transpose the at least one driving roller between an disengaged position and an engaged position; a slicer to cut said film of the pre-determined length; a driving unit configured to confer motion to said at least one driving roller to drive the film for a pre-determined length. The present disclosure further relates to a cartridge for storing and ejecting a film rolled around a bobbin.

### TECHNICAL FIELD

The present disclosure relates generally to the field of dispenser. In particular, the present disclosure relates to a film dispensing device capable of delivering an active ingredient to a user. Aspects of the present disclosure further relates to a cartridge for storing and ejecting a film comprising an active ingredient.

### BACKGROUND

Background description includes information that may be useful in understanding the present invention. It is not an admission that any of the information provided herein is prior art or relevant to the presently claimed invention, or that any publication specifically or implicitly referenced is prior art.

Among the existing methods for drug administration, oral route is the most preferred routes as it is more convenient, cost effective, and ease of administration leads to high level of patient compliance. However, in certain cases it is problematic to administer the drugs orally because of swallowing difficulty such as in pediatric and geriatric patients who have fear of choking. Also because orally swallowed drugs are absorbed in intestines, they are susceptible to degradation in gastrointestinal tract and side-effects because the active ingredients are metabolized in the liver resulting in first pass effect.

There have, therefore, been efforts to develop more efficient and safer methods of drug delivery which have resulted in bringing out fast dissolving drug delivery systems. The fast dissolving drug delivery systems were first invented in the late 1970s with an aim to overcome swallowing difficulties associated with tablets and capsules for pediatric and geriatric patients. Subsequently Buccal drug delivery was developed and has lately become an important route of drug administration. Various bio-adhesive mucosal dosage forms have been developed, which includes adhesive tablets, gels, ointments, patches, and more recently polymeric films. These have gained currency in the pharmaceutical industry due to their unique properties and specific advantages like no need of water for disintegration, accurate dosing, rapid onset of action, ease of transportability, ease of handling, pleasant taste and improved patient compliance.

Of the above mucosal dosage forms, thin-film drug delivery that involves fast dissolving films have acquired great importance in the pharmaceutical industry. Thin-film drug delivery uses a dissolving film or oral drug strip to administer drugs via absorption in the mouth (buccally or sublingually). A film is prepared using hydrophilic polymers that rapidly dissolves on the moist surface of tongue or buccal cavity, to release the medication for oromucosal and intragastric absorption, without chewing and intake of water. As the strip dissolves, the drug can enter the blood stream enterically, buccally or sublingually. Typically, the thin-film strips are designed for oral administration, with the user placing the strip on or under the tongue (sublingual) or along the inside of the cheek (buccal).

The thin film technology offers a convenient way of dosing medication-pharmaceutical and herbal medicines, not only to special population groups like pediatric, geriatric, bedridden patients, mentally ill patients, but also to the general population. The sublingual mucosa is relatively permeable due to thin membrane and large veins. It gives rapid absorption and instant bioavailability of drugs due to high blood flow. As the fast-dissolving film is taken through the sublingual route, rapid absorption of drug is possible, which finally leads to quick onset of drug action and prevent the first pass-metabolism of the drugmaking the medication more bioavailable.

Thin-film strips are typically packed in sealed child-resistant foil pouches, and each piece, also known as oral wafer, comprising one dose is similar in size, shape and thickness to a postage stamp. A user has to handle the strip or wafer from its edges and place in oral cavity under his tongue. As can be seen, present method of providing and administering the thin film strips to a user is not very convenient. Storage and carrying the pouches can be troublesome. Even handing the strip after it has been removed from the pouch has to be done carefully as improper handling can result in inconsistent dose delivered to the user.

There is therefore a need in the art to develop a film dispensing device capable of delivering an active ingredient (active ingredient can be a pharmaceutical agent, herbal ingredient, a nutraceutical agent, a cosmetic agent) to a user and that can overcome the limitations associated with the conventional film dispensing device.

### OBJECTS

An object of the present disclosure is to provide a film dispensing device that generally overcomes the deficiencies found in the conventional dispensing device.

Another object of the present disclosure is to provide a film dispensing device for dispensing of a film.

Another object of the present disclosure is to provide a film dispensing device for dispensing of a film impregnated with at least one active ingredient.

Another object of the present disclosure is to provide a film dispensing device capable of delivering an active agent in a controlled manner.

Another object of the present disclosure is to provide a cartridge for storing and ejecting a film rolled around a bobbin.

Another object of the present disclosure is to provide a film dispensing device for dispensing of a film without any human intervention.

Another object of the present disclosure is to provide a film dispensing device capable of delivering an active agent without any overdose or under-dose.

Another object of the present disclosure is to provide a film dispensing device capable of delivering an active agent under sterile condition.

Another object of the present disclosure is to provide a film dispensing device capable of delivering an active agent without any gastro-intestinal discomfort.

Another object of the present disclosure is to provide a film dispensing device that is easy to operate.

Another object of the present disclosure is to provide a portable film dispensing device.

Another object of the present disclosure is to provide a film dispensing device that requires user approval for dispensing of film.

### SUMMARY OF THE INVENTION

The present disclosure relates generally to the field of dispenser. In particular, the present disclosure relates to a film dispensing device capable of delivering an active ingredient to a user. Aspects of the present disclosure further relates to a cartridge for storing and ejecting a film comprising an active ingredient.

An aspect of the present disclosure relates to a film dispensing device, said device including: a housing defining a dispensing orifice; a cartridge storing a film rolled around a bobbin, said cartridge including: a chamber holding said rolled film therewithin, said chamber defined by base, front wall, rear wall and a plurality of side walls of said cartridge, wherein said front wall defines an opening to allow ejection of said film; at least one driving roller to drive said film; a roller biasing element, said roller biasing element configured to transpose the at least one driving roller between an disengaged position and an engaged position; a slicer to cut said film of the pre-determined length; a driving unit configured to confer motion to said at least one driving roller, wherein said driving unit is configured to control said at least one driving roller to drive the film for a pre-determined length.

In an embodiment, the driving unit is further configured to bring the at least one driving roller in an engaged position. In an embodiment, the device further includes a film carrier track configured to convey said ejected film from said opening to the dispensing orifice for dispensation thereof to a user. In an embodiment, the opening is in mating relationship with said dispensing orifice to allow dispensation of said ejected film from the dispensing orifice. In an embodiment, the device further includes a sensor configured to detect any or a combination of length of the ejected film and quality of the ejected film. In an embodiment, the slicer is vertically displaceable along a guiding surface. In an embodiment, the film includes a film impregnated with any or a combination of at least one pharmaceutical agent, at least one herbal ingredient, at least one nutraceutical and at least one cosmetic agent. In an embodiment, the film includes a film capable of oral disintegration upon ingestion thereof.

Another aspect of the present disclosure relates to a cartridge for storing and ejecting a film rolled around a bobbin, said cartridge including: a chamber to hold said rolled film therewithin, said chamber defined by base, front wall, rear wall and a plurality of side walls of said cartridge, wherein said front wall defines an opening to allow ejection of said film; at least one driving roller to drive said film; a roller biasing element, said roller biasing element configured to transpose the at least one driving roller between an disengaged position and an engaged position; and a slicer to cut said film of the pre-determined length, wherein said slicer is vertically displaceable along a guiding surface. In an embodiment, the film includes a film impregnated with any or a combination of at least one pharmaceutical agent, at least one herbal ingredient, at least one nutraceutical and at least one cosmetic agent. In an embodiment, the film includes a film capable of oral disintegration upon ingestion thereof.

In an embodiment, the dispensing device can incorporate smart features to enable record keeping in respect of timing, dose size, frequency of doses and symptoms before and after a prescribed dose. The maintained records can help in allowing doctors and patients to gain a better understanding of how the medication is functioning to develop a customized treatment program. In an embodiment, the dispenser can incorporate a display screen configured to display symptoms before and after a prescribed dose has been administered to a patient.

In an embodiment, the dispensing device can further incorporate means to communicate data in real time or on as required basis to various stakeholders such as doctor, care giver, drug stores, pharmaceutical companies etc. The means for communication can be a wireless communication means that can enable data transfer from the dispenser to external functional units or networks. Communication between the dispenser and external functional units or networks may be accomplished through any suitable communication channels such as Bluetooth, Wi-Fi, GSM communication means such as 3G etc.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary image 100 of the dispensing device, realized in accordance with an embodiment of the present disclosure.

FIG. 2A illustrates an exemplary exposed front view depicting various parts/elements of a dispensing device, realized in accordance with an embodiment of the present disclosure.

FIG. 2B illustrates an exemplary exposed front view depicting various parts/elements of a variant of a dispensing device as illustrated in FIG. 2A, realized in accordance with an embodiment of the present disclosure.

FIG. 3 illustrates an exemplary exposed side view of a cartridge, realized in accordance with an embodiment of the present disclosure.

FIG. 4 illustrates an exemplary exposed top view of a cartridge, realized in accordance with an embodiment of the present disclosure.

FIG. 5 that illustrates an exemplary block diagram 500 indicating various functional subsystems of the disclosed strip/film dispenser device, realized in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

Various terms as used herein. To the extent a term used in a claim is not defined below, it should be given the broadest definition persons in the pertinent art have given that term as reflected in printed publications and issued patents at the time of filing.

The present disclosure relates generally to the field of dispenser. In particular, the present disclosure relates to a film dispensing device capable of delivering an active ingredient to a user. Aspects of the present disclosure further relates to a cartridge for storing and ejecting a film comprising an active ingredient.

An aspect of the present disclosure relates to a film dispensing device, said device including: a housing defining a dispensing orifice; a cartridge storing a film rolled around a bobbin, said cartridge including: a chamber holding said rolled film therewithin, said chamber defined by base, front wall, rear wall and a plurality of side walls of said cartridge, wherein said front wall defines an opening to allow ejection of said film; at least one driving roller to drive said film; a roller biasing element, said roller biasing element configured to transpose the at least one driving roller between an disengaged position and an engaged position; a slicer to cut said film of the pre-determined length; a driving unit configured to confer motion to said at least one driving roller, wherein said driving unit is configured to control said at least one driving roller to drive the film for a pre-determined length.

In an embodiment, the driving unit is further configured to bring the at least one driving roller in an engaged position. In an embodiment, the device further includes a film carrier track configured to convey said ejected film from said opening to the dispensing orifice for dispensation thereof to a user. In an embodiment, the opening is in mating relationship with said dispensing orifice to allow dispensation of said ejected film from the dispensing orifice. In an embodiment, the device further includes a sensor configured to detect any or a combination of length of the ejected film and quality of the ejected film. In an embodiment, the slicer is vertically displaceable along a guiding surface. In an embodiment, the film includes a film impregnated with any or a combination of at least one pharmaceutical agent, at least one herbal ingredient, at least one nutraceutical and at least one cosmetic agent. In an embodiment, the film includes a film capable of oral disintegration upon ingestion thereof.

Another aspect of the present disclosure further relates to a cartridge for storing and ejecting a film rolled around a bobbin, said cartridge including: a chamber to hold said rolled film therewithin, said chamber defined by base, front wall, rear wall and a plurality of side walls of said cartridge, wherein said front wall defines an opening to allow ejection of said film; at least one driving roller to drive said film; a roller biasing element, said roller biasing element configured to transpose the at least one driving roller between an disengaged position and an engaged position; and a slicer to cut said film of the pre-determined length, wherein said slicer is vertically displaceable along a guiding surface. In an embodiment, the film includes a film impregnated with any or a combination of at least one pharmaceutical agent, at least one herbal ingredient, at least one nutraceutical and at least one cosmetic agent. In an embodiment, the film includes a film capable of oral disintegration upon ingestion thereof.

In an embodiment, the dispensing device can incorporate smart features to enable record keeping in respect of timing, dose size, frequency of doses and symptoms before and after a prescribed dose. The maintained records can help in allowing doctors and patients to gain a better understanding of how the medication is functioning to develop a customized treatment program. In an embodiment, the dispenser can incorporate a display screen configured to display symptoms before and after a prescribed dose has been administered to a patient.

In an embodiment, the dispensing device can further incorporate means to communicate data in real time or on as required basis to various stakeholders such as doctor, care giver, drug stores, pharmaceutical companies etc. The means for communication can be a wireless communication means that can enable data transfer from the dispenser to external functional units or networks. Communication between the dispenser and external functional units or networks may be accomplished through any suitable communication channels such as Bluetooth, Wi-Fi, GSM communication means such as 3G etc.

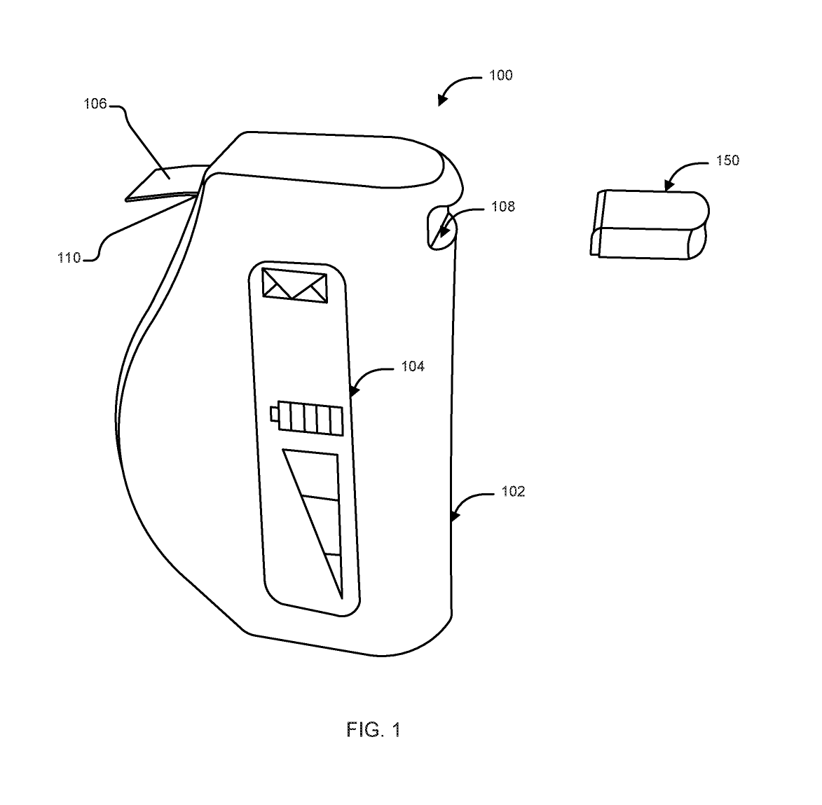

FIG. 1 illustrates an exemplary image depicting a dispensing device 100 realized in accordance with an embodiment of the present disclosure. As shown, the dispensing device 100 includes a housing 102 defining a dispensing orifice 110, and a slot 108 for receiving a cartridge 150 having stored therein at least one film containing a predetermined dosage of medication. The screen 104 provided on the dispensing device can indicate status of Wi-Fi, GSM connectivity, effectiveness of medication dose and battery status. The screen 104 can be further used to display and/or enter different data and information that the dispensing device (alternatively referred to herein as dispenser) may provide or may be required to process or store. Also shown in view 100 is a single film (alternatively referred as strip) 106 projecting out of the dispenser which a user can directly utilize for its intended purpose. In an embodiment, the film is an orally disintegrating film that a user can place below his tongue to get the medication dispensed in form of the film. Although few embodiments of the present disclosure are described herein with reference to sublingual films, a person skilled in the art would appreciate that the dispensing device of the present disclosure may find its utility for dispensation of a variety of articles such as film or layered products or consumables and all such applications are completely within the scope and spirit of the present invention.

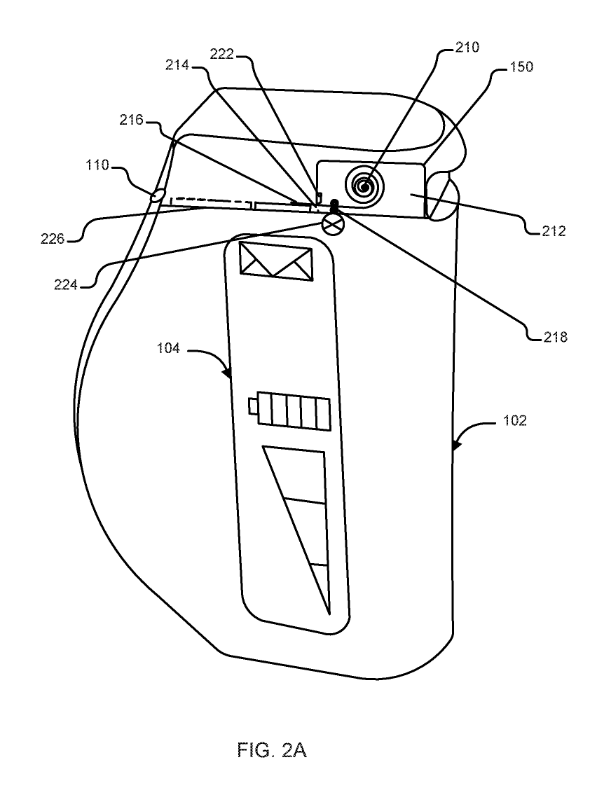

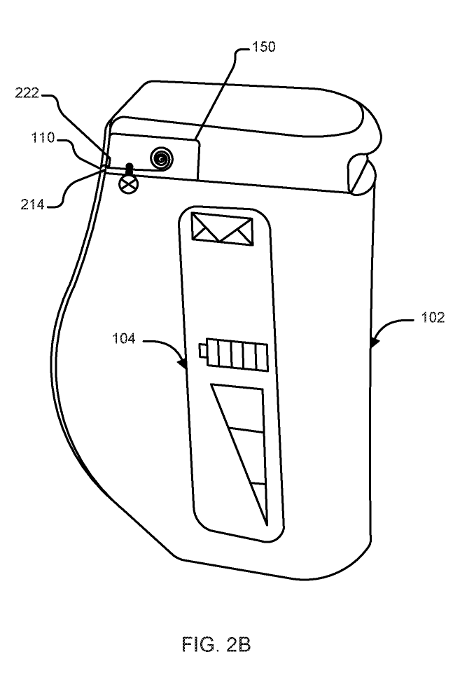

FIG. 2A illustrates an exemplary exposed front view depicting various parts/elements of a dispensing device 100, realized in accordance with an embodiment of the present disclosure. As can be seen from FIG. 2A, the film dispensing device 100 includes a housing 102 defining a dispensing orifice 110, a cartridge 150 for storing a film rolled around a bobbin 210, said cartridge including a chamber 212 to hold a film rolled around a bobbin 210 therewithin and, an opening 214 to allow ejection of said film 216, at least one driving roller 218 to drive said film, a slicer 222 to cut said film of the pre-determined length; a driving unit 224 configured to confer motion to said at least one driving roller to drive the film for a pre-determined length. As can also be seen, the device includes a film carrier track 226 configured to convey the ejected film 216 from the opening 214 provided on cartridge to the dispensing orifice 110 of the dispensing device for dispensation thereof to a user.

FIG. 2B illustrates an exemplary exposed front view depicting various parts/elements of a variant of a dispensing device realized in accordance with an embodiment of the present disclosure. As can be seen from FIG. 2B, the dispensing device includes a cartridge 150 placed in a position such that opening 214 for ejection of a film of defined length from the cartridge is in mating relationship with a dispensing orifice 110 of the dispenser allowing for ready/direct dispensation of said ejected single film from the dispensing orifice to a user.

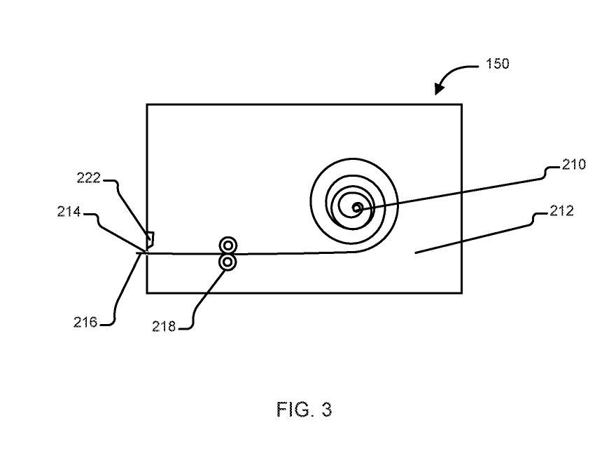

FIG. 3 illustrates an exemplary exposed front view of a cartridge, realized in accordance with an embodiment of the present disclosure. As can be seen in FIG. 3, the cartridge 150 for storing and ejecting a film rolled around a bobbin 210, said cartridge includes a chamber 212 to hold the film rolled around the bobbin 210, an opening 214 to allow ejection of said film 216, at least one driving roller 218 to drive said film, and a slicer 222 to cut said film of the pre-determined length. As can also be seen from the figure, the cartridge includes a pair of roller, wherein at least one roller serves the purpose of driving roller (shown as 218) and the other roller serves the purpose of an idle roller. A person skilled in the art would appreciate that instead of rollers, any other mechanism such as guiding track and the likes can be used to serve the purpose of moving forward/ejecting the film without departing from the scope of the present disclosure.

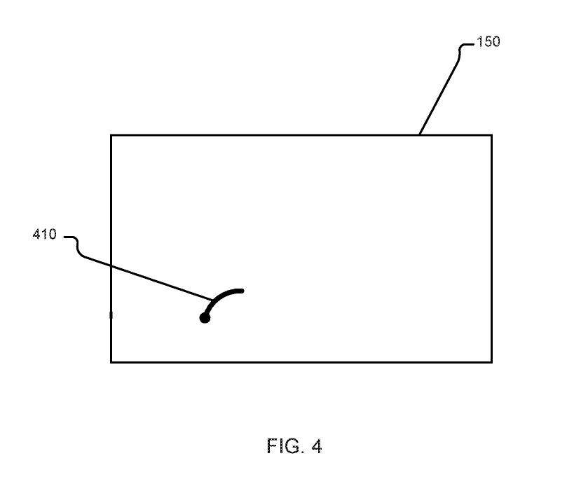

FIG. 4 illustrates an exemplary front view of the cartridge 150 depicting the roller biasing element 410 in a position engaging the driving roller with the film, in accordance with an embodiment of the present disclosure. As can be seen in FIG. 4, a roller biasing element 410 is provided as part of the cartridge to transpose the driving roller 218 between a disengaged position and an engaged position. Normally, the roller biasing element keeps the driving roller in an disengaged position. The roller biasing element may include a biasing means such as spring, tensioner and the like means as known to or appreciated by a person skilled in the art. When the driving roller is in disengaged position, the driving roller is away from the film (i.e. the driving roller is not in contact with the film) and hence, even if motion is conferred to the driving roller, the motion do not get transferred to the film. The dispenser is configured to first authenticate the user. In an embodiment, the dispenser/dispensing device is in communication with a computing device. When the user requests for dispensation of the film, the dispensing device can authenticate the user. Alternatively, the computing device is configured to authenticate the user and then send signal to the dispensing device. In an embodiment, the dispenser/dispensing device is in communication with a computing device running thereon an app that can authenticate the user. Upon successful authentication, the roller biasing element is actuated to bring the driving the driving roller in engaged position (i.e. in contact with the film) such that the motion of driving roller can be translated to motion of the film.

Coming to operation of the dispensing device 100, the cartridge 150 is inserted in the slot 108 provided as part of the housing 102 of the device. Once, the cartridge 150 is received inside said slot 108, the user can actuate the device for effecting removal of a film of predefined length from the cartridge. The user may then input the required dose of the medication and/or length of the film containing appropriate amount of the medication to be dispensed by the dispenser in form a film of defined length. The dispenser of the present disclosure is configured to detect the amount/unit of medication present per unit length of the film such as by reading the barcode of the cartridge that includes such information stored therein. Alternatively, the user may input such information manually using the input device operatively connected with the dispensing device. In an embodiment, the dispensing device is operatively coupled with a computing device (such as by means of provision of an app running over such computing device) that can serve as an input device for inputting the requisite medication details. Alternatively, the dispenser is configured to fetch/receive the requisite medication details from a computing device associated with a medical personnel and/or a server with requisite medication details stored therein. Based on the medication detail, the dispenser can calculate the unit length of the film that can fulfill the medication requirement of the user. Once, the dispenser fetch/receive/calculate the unit length of the film, the dispenser can determine the motion of the driving roller that may effect displacement of the film by said unit length of the film. On pressing the actuator or by providing command to said device to dispense the film, (for example, from a computing device operatively coupled with the dispensing device through an app), the roller biasing member brings the driving roller in an engaged position such that it can move the film towards the opening followed by motion/revolution of the driving roller to move the film towards the slicer. Once the film of defined length moves forward the slicing unit, the slicing unit/slicer/cutter travels vertically along a guiding surface and cut the film to be ejected from the opening.

In case the cartridge is engaged with the dispensing device as shown in FIG. 2A, wherein the opening of cartridge and the dispensation orifice of dispenser are in mating relationship, the film of pre-defined length is dispensed directly/readily to the user. In case the cartridge is engaged with the dispensing device as shown in FIG. 2B, wherein the opening of cartridge and the dispensation orifice of dispenser are not in mating relationship, as the film or part thereof moves past the opening of the cartridge, the film carrier track initiates its movement towards the dispensation orifice. The ejected film of defined length then travels onto the film carrier track to be conveyed from the opening to the dispensing orifice for dispensation thereof to the user. The sensor provided as part of the dispensing device, continuously monitors the ejected film for any discrepancies such film being physically damaged during its dispensation. In case of detection of any discrepancies, the sensor signals the controller of the dispensing device which in turn can take suitable corrective measures and/or flags the event to a computing device associated with the dispensing device.

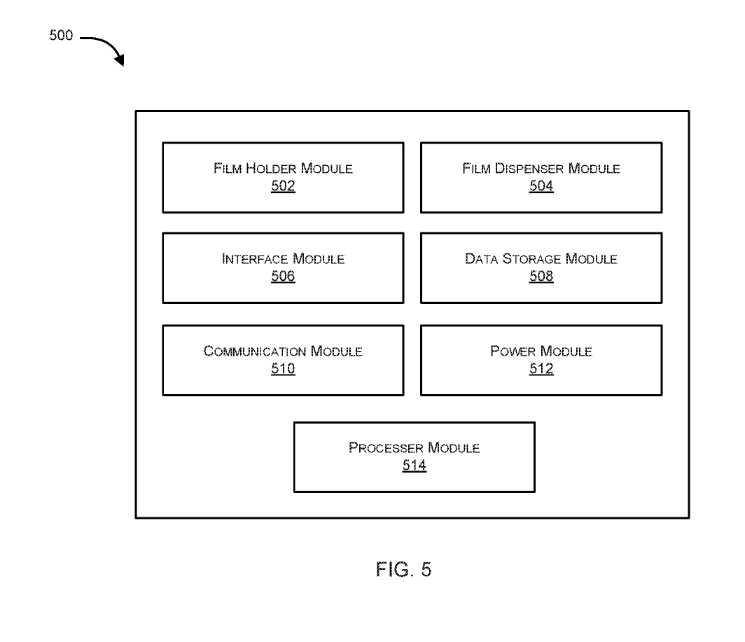

Referring now to FIG. 5 that illustrates an exemplary block diagram 500 indicating various functional subsystems of the disclosed strip/film dispenser. The dispenser of the present disclosure can incorporate a film holder module 502, a film dispenser module 504, an interface module 506, a data storage module 508, a communication module 510, a power module 512 and a processer module 514.

In an embodiment, the film holder module 502 can be configured to hold a film carrying a pharmaceutical or herbal formulation for sublingual delivery in roll form. The roll can last for number of doses sufficient for few days thus enabling a user to carry his medicine requirement in a convenient manner. In an exemplary embodiment, the roll can carry 50 doses. User if required can carry replacement rolls/cartridge to refill the dispenser. As can be seen, it provides hygienic storage without user having to touch the thin film strip.

In an embodiment, the film dispenser module 504 can be configured to dispense precise length of the film from the roll. The film dispenser module 504 can enable free end of the strip to project out of the dispenser which user can hold between his lips and pull. The film dispenser module 504 can precisely control length of the film allowed to be pulled thus maintaining a precise control on the dose. In an embodiment, the film dispenser module 504 can incorporate means to facilitate cutting of the strip after the required length has been pulled. The free end of the strip/film can remain within the dispenser and can project out only when user activates the dispenser for taking next dose.

In an embodiment, the film dispenser module 504 can be configured to dispense a fixed dose or alternatively can be configured to vary the dose depending on symptoms or certain physiological parameters of the user. In an embodiment, the interface module 506 can be configured to enable user to interact with the dispenser. The interaction can be to activate the dispenser to dispense a dose, to enter symptoms or physiological parameters of the user before and after a dose, and other like information. In an embodiment, the interface module 506 can incorporate a touch screen for user to view and also enter different data and information that the dispenser may provide or may be required to process or store.

In an embodiment, the data storage module 508 can be configured to store information such as of timing and frequency of doses, symptoms and/or physiological parameters before and after a dose etc. The stored information can provide records to help doctors and patients to gain a better understanding of how the medicine is functioning to develop a customized treatment program. It can also allow pharmaceutical and nutraceutical companies to learn about the effectiveness of their medicine after clinical trials and can further allow them to stay connected to the patients using their medicines to gather data and perform analytics.

In an embodiment, the communication module 510 can be configured to communicate data in real time or on as required basis to various stakeholders such as doctor, care giver, pharmaceutical companies etc. The means for communication can be a wireless communication means that can enable data transfer from the smart dispenser to other computing devices by either or combination of Bluetooth, Wi-Fi, GSM communication means such as 3G etc. Data transfer from the dispenser to another computing device can be in real time or as and when required.

In an embodiment, the processer module 514 can be configured to process data provided by user in respect of physiological parameters, symptoms etc. and based on pre-fed data provide dose to be administered. The processer module 514 can thereafter suitably control the the thin film dispenser module 504 to dispense the required dose.

In an embodiment, the power module 512 can be configured to meet power requirement of various functional subsystems of the dispenser. The power module 512 can comprise a rechargeable battery with connected charging port and charging circuit. In an exemplary embodiment, the battery once charged can last for up to 5 days.

Thus the disclosed film dispenser provides a convenient and efficient way to store and administer doses of pharmaceutical or herbal formulations on thin film strips. It further enables record keeping in respect of timing and frequency of doses, symptoms before and after a dose and the maintained records can help doctors and patients to gain a better understanding of how the medicine is functioning to develop a customized treatment program.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides a film dispensing device that generally overcomes the deficiencies found in the conventional dispensing device.

The present disclosure provides a film dispensing device for dispensing of a film.

The present disclosure provides a film dispensing device for dispensing of a film impregnated with at least one active ingredient.

The present disclosure provides a film dispensing device capable of delivering an active agent in a controlled manner.

The present disclosure provides a cartridge for storing and ejecting a film rolled around a bobbin.

The present disclosure provides a film dispensing device for dispensing of a film without any human intervention.

The present disclosure provides a film dispensing device capable of delivering an active agent without any overdose or under-dose.

The present disclosure provides a film dispensing device capable of delivering an active agent under sterile condition.

The present disclosure provides a film dispensing device capable of delivering an active agent without any gastro-intestinal discomfort.

The present disclosure provides a film dispensing device that is easy to operate.

The present disclosure provides a portable film dispensing device.

The present disclosure provides a film dispensing device that requires user approval for dispensing of film.

I/We claims:

1. A film dispensing device, said device comprising:
a housing defining a dispensing orifice;
a cartridge storing a film rolled around a bobbin, said cartridge comprising:
a chamber holding said rolled film therewithin, said chamber defined by base, front wall, rear wall and a plurality of side walls of said cartridge, wherein said front wall defines an opening to allow ejection of said film;
at least one driving roller to drive said film;
a roller biasing element, said roller biasing element configured to transpose the at least one driving roller between an disengaged position and an engaged position;
a slicer to cut said film of the pre-determined length; and
a driving unit configured to confer motion to said at least one driving roller, wherein said driving unit is configured to control said at least one driving roller to drive the film for a pre-determined length.

2. The device as claimed in claim 1, wherein said driving unit is further configured to bring the at least one driving roller in an engaged position.

3. The device as claimed in claim 1, wherein said device further comprises a film carrier track configured to convey said ejected film from said opening to the dispensing orifice for dispensation thereof to a user.

4. The device as claimed in claim 1, wherein said opening is in mating relationship with said dispensing orifice to allow dispensation of said ejected film from the dispensing orifice.

5. The device as claimed in claim 1, wherein said device further comprises a sensor configured to detect any or a combination of length of the ejected film and quality of the ejected film.

6. The device as claimed in claim 1, wherein said slicer is vertically displaceable along a guiding surface.

7. The device as claimed in claim 1, wherein said film comprises a film impregnated with any or a combination of at least one pharmaceutical agent, at least one herbal ingredient, at least one nutraceutical and at least one cosmetic agent.

8. The device as claimed in claim 1, wherein said film comprises a film capable of oral disintegration upon ingestion thereof.

9. A cartridge for storing and ejecting a film rolled around a bobbin, said cartridge comprising:
a chamber to hold said rolled film therewithin, said chamber defined by base, front wall, rear wall and a plurality of side walls of said cartridge, wherein said front wall defines an opening to allow ejection of said film;
at least one driving roller to drive said film;
a roller biasing element, said roller biasing element configured to transpose the at least one driving roller between an disengaged position and an engaged position; and
a slicer to cut said film of the pre-determined length, wherein said slicer is vertically displaceable along a guiding surface.

10. The device as claimed in claim 9, wherein said film comprises a film impregnated with any or a combination of at least one pharmaceutical agent, at least one herbal ingredient, at least one nutraceutical and at least one cosmetic agent.

11. The device as claimed in claim 10, wherein said film comprises a film capable of oral disintegration upon ingestion thereof.
